(19) United States
(12) Patent Application Publication
(10) Pub. No.: US 2026/0188329 A1
(43) Pub. Date: Jul. 2, 2026

(54) SYSTEMS AND METHODS FOR DOWNLINK AUDIO PROCESSING

(71) Applicant: Agora Lab, Inc., Santa Clara, CA (US)

(72) Inventors: Siqiang Yao, Shanghai (CN); Guangjian Xu, Shanghai (CN); Sen Li, Shanghai (CN); Yi Lv, Shanghai (CN); Fangfang Wu, Shanghai (CN); Jinlong Shang, Shanghai (CN); Liming Zhou, Shanghai (CN); Ruofei Chen, Shanghai (CN)

(21) Appl. No.: 19/004,188

(22) Filed: Dec. 27, 2024

(51) Int. Cl. G10L 19/008

(52) U.S. Cl. CPC G10L 19/008

(57) ABSTRACT

Systems and methods for downlink audio processing are provided. In some embodiments, the methods and systems for downlink audio processing include receiving an audio signal at an uplink device. The audio signal is then converted into a near-end signal. A far-end signal (signal played on a speaker by the uplink device) is collected. The near-end signal and the far-end signal are encoded into an encoded bit stream. The encoded signal is then transmitted to the downlink device. The downlink device decodes the encoded bit stream to render a decoded near-end signal and a decoded far-end signal. This may include a jitter buffer to ensure signal synchronization. The downlink device may then perform audio processing using the decoded near-end signal and the decoded far-end signal to generate processed audio, including acoustic echo cancellation, adaptive noise supression and automatic gain control. Additionally, this processed audio may be subject to additional processing using machine learning algorithms.

### BACKGROUND

The present invention relates in general to the field of audio processing, and more specifically to methods, computer programs and systems for downlink audio processing. Generally, initial audio processing including noise cancellation and gain control occurs at the recording device. However, in some circumstances the device may not be well suited for audio processing tasks.

In current systems, such as the system illustrated at 100 in FIG. 1, the primary/near field audio signal 110 is received at a recorder 120 of a frontend device (represented by the dotted line box). The recorder 120 includes a microphone or other transducer device. The front end recording may be provided to an acoustic echo cancellation (AEC) module 140 for noise cancellation along with a far-end reference signal 115 which is what has been played previously via a loudspeaker of the device. The AEC module 140 subtracts out the time delayed far end reference signal 115 from the near end audio signal 110 to remove echo artifacts. The adjusted signal is then provided to a module that analyzes the ambient noise.

This adaptive noise suppression (ANS) 150 adjusts the signal further to remove ambient noise from the signal. The further adjusted signal is provided to an automatic gain controller 160 which is a circuit that is a closed-loop feedback regulating circuit that adjusts the relative amplification of the signal to ensure a consistent volume level. This results in a clean, consistent audio signal that may be encoded and compressed at an encoder 170 and then transmitted via an antenna and transmission circuitry (not illustrated). The transmission may be via local Wi-Fi, cellular, via the internet, or by some combination of the above. This transmission via the cloud 175 results in the signal being routed to a decoder 180 located in an end/downlink device. A player 190 (optional) may then play the decoded signal 195. Additionally, or alternatively, the decoded signal may be subject to further processing, such as speech recognition and other Machine Learning (ML) analysis.

Generally, the front-end device is light weight device, with limited processing capability and low power. The backend system, however, may be extremely robust, with ample processing resources. Examples of the front-end systems include smart speakers, smart doorbells, IP cameras, and other Internet of Things (IOT) devices. Conversely, backend systems may include server farms, smartphones and other relatively computationally-rich devices. The front-end devices have extremely limited computational resources for audio processing, let alone Artificial Intelligence (AI) processing of the signals. As such, audio processing may be slow, or difficult, using the front-end devices.

Given that there is great value in audio processing of received audio signals at IOT devices which may struggle to provide such audio processing, downlink audio processing is provided.

### SUMMARY

The present systems and methods relate to audio processing, and particularly to downlink audio processing. Such systems and methods enable improved and efficient audio processing when the front-end device lacks computational resources to efficiently process audio signals.

In some embodiments, the methods and systems for downlink audio processing includes receiving an audio signal at an uplink device. The audio signal is then converted into a near-end signal. A far-end signal (signal played on a speaker by the uplink device) is collected. The near-end signal and the far-end signal are both mono-signals. These two mono signals may be combined in a manner that allows for compression using a stereo encoder or interleaving both signals and encoding as a mono-signal. Encoding the near-end signal and the far-end signal utilizes an audio codec with stereo coding capabilities (such as Opus stereo) in some embodiments. In alternate embodiments, the encoding the near-end signal and the far-end signal utilizes a mono coder that interleaves the near-end signal and the far-end signal in a time domain. Examples of the mono coder may include using G.711 or G.722 codecs. Regardless of how the signals are encoded, they are then transmitted to the downlink device.

The downlink device decodes the mono-signal to render a decoded near-end signal and a decoded far-end signal. This may include a jitter buffer to ensure signal synchronization. The downlink device may then perform audio processing using the decoded near-end signal and the decoded far-end signal to generate processed audio. The processing may include any (or many) of acoustic echo cancellation, adaptive noise suppression and automatic gain control. Additionally, this processed audio may be subject to additional processing using at least one machine learning algorithm.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example block diagrams of a system for traditional audio processing, in accordance with some embodiment;

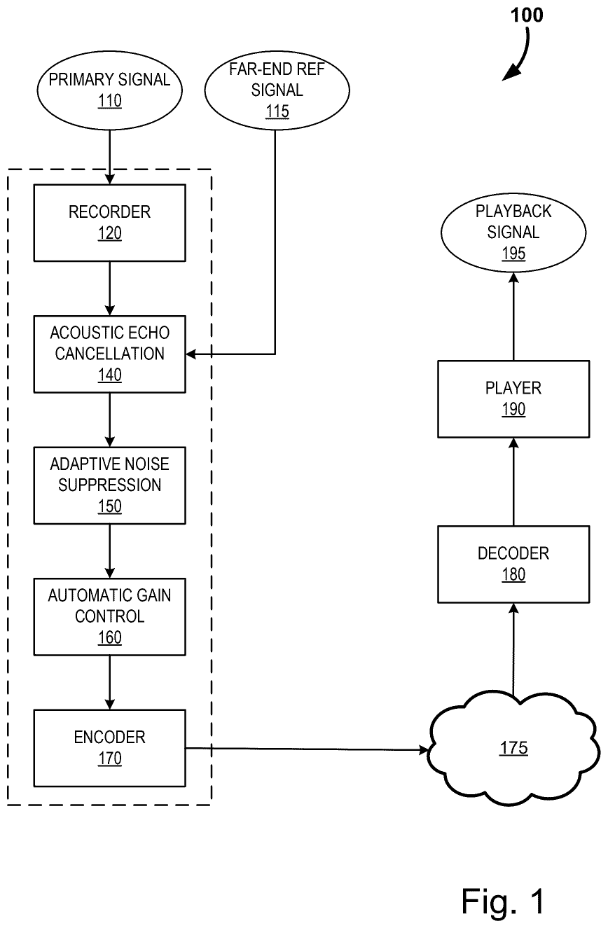

FIG. 2 is an example block diagram for a system for downlink audio processing, in accordance with some embodiments;

FIG. 3 is a flow diagram for an example process of downlink audio processing, in accordance with some embodiments;

FIG. 4 is a flow diagram for an example sub-process of the processing performed on the audio signals, in accordance with some embodiments; and

FIGS. 5A and 5B are illustrations of computer systems capable of implementing the downlink audio processing, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

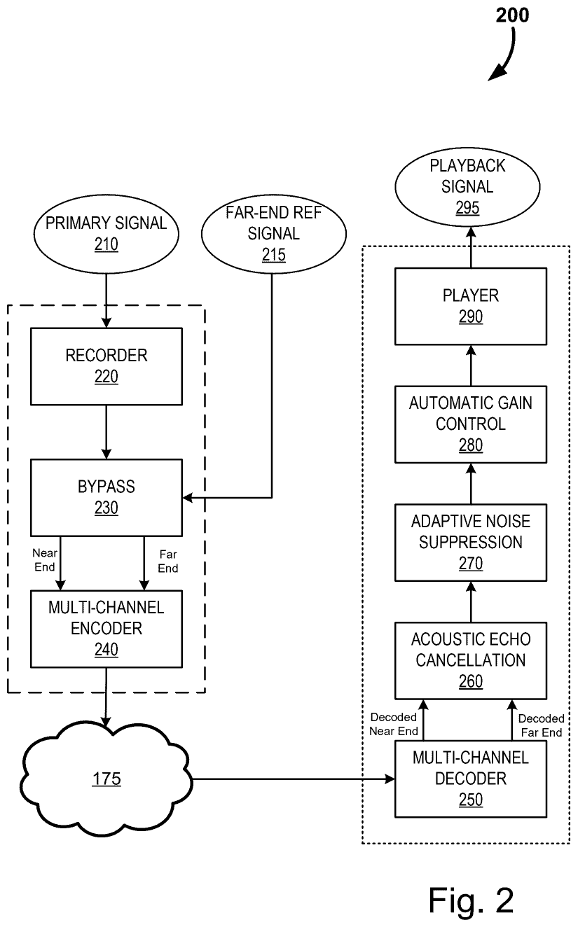

The present invention relates to systems and methods for downlink audio processing. To facilitate discussions, FIG. 2 provides an example system for said downlink audio processing, shown generally at 200. Here the primary near-end audio signal 210 is picked up by a microphone and recorded by the recorder 220. The recorder may supply the signal to an bypass circuit 230 which completely bypasses the uplink audio processing modules. This bypass circuit may also receive the far end reference signal 215 which was played on the system loudspeaker. The bypass circuit may send the near end signal and the far end signal to a specially configured multi-channel encoder 240. The multi-channel encoder 240 may encode the two signals using a stereo audio codec or through interleaving the two signals in the time domain into a mono signal. Regardless of how the signal is encoded, the resulting encoded signal is transmitted to the cloud 175. The cloud 175 may include a local area network, a wide area network, the internet, acellular network, or any combination thereof.

A dotted-line box outlines all components and activities that occur within the recording device. As noted previously, the recording device may consist of a computationally weak device, such as a smart speaker, smart watch, smart doorbell, camera, or other Internet of Things (IOT) device. Such devices may lack the computational (or power) needed to perform even relatively simple audio processing, let alone enhanced AI analysis or the like.

Conversely, the downlink device that receives the encoded signal, represented by the fine-dotted-line box, may have significantly more computational resources enabled. For example, the downlink device may include a smart phone, iPad or similar tablet, computer, or even a server unit/farm. The downlink device may receive the encoded signal and utilize a specially configured multi-channel decoder 250 to decode the encoded bit stream into the two constituent signals: the decoded near end signal and the decoded far end signal when the encoded signal is an interleaved mono signal, or a stereo decoder may be utilized when the encoded signal includes a stereo encoding.

Using these two signals the AEC module 260 may perform noise cancellation processing. This results in an altered acoustic signal whereby the far end signal is subtracted from the near end signal to remove loudspeaker echoes. An adaptive noise suppression (ANS) module 270 further alters the source signal to remove the ambient noises that are collected by the microphone. This subtraction of ambient noises that are identified further cleans the signal such that it only includes the audio of interest (e.g., the speaker's voice for example).

Lastly, an automatic gain control (AGC) circuit 280 may include a closed feedback loop for modulating the amplification of the altered audio signal to ensure the resulting signal has a relatively consistent amplitude. This signal may be provided to a player 290 which generated a playback signal 295 via the device speaker, and/or the signal may be provided to further downstream audio processing circuitry. For example, the downlink device may perform speech recognition or other AI processing of the audio signal. Alternatively, the resulting signal may be recorded in the cloud, undergo content censoring, or other operations.

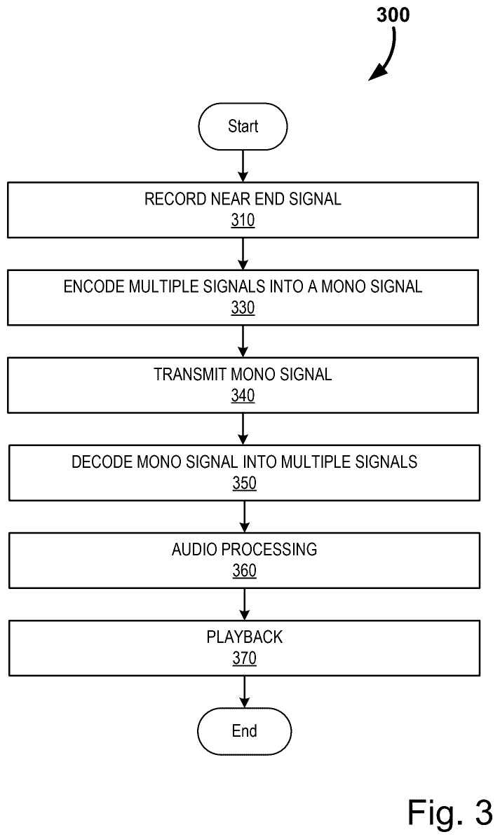

FIG. 3 provides the example process 300, for downlink audio processing. Initially the near end signal is converted from an acoustic wave to an electrical signal using a transducer/microphone, at 310. This raw near end signal is provided, along with a far end signal to a multi-channel encoder. The far end signal is the electrical signal that was supplied to the loudspeaker of the device for playing. For example, a ringing tone of a smart doorbell could be played by the device. This signal, when played, is picked up by the microphone, in a time delayed fashion, in the near end signal. It is critical for proper signal processing and playback that these echoes produced are removed from the audio (near end) signal.

In this example system, the near end signal and the far end signal are then encoded into an encoded signal, at 330. Encoding may be using an audio codec with stereo or multi-channel coding capabilities, such as Opus stereo. Alternatively, a mono coder (such as G.711/722) may be modified to transmit a multi-channel stream. For example, they may be interleaved in a time domain and transmitted as a mono signal.

The encoded signal may then be transmitted, at 340, from the capture device to a downlink device. As noted before, the receiving device may be an extremely lightweight IOT device, such as a smart speaker, smart doorbell, camera or the like. These devices have extremely limited computational resources and may be unable to efficiently process the audio signal. In contrast, the downlink device may have significantly more computational resources available. Downlink devices could include a smart phone, tablet, computer or server. In some cases, the transmission of the signal may be local, such as through a LAN or Bluetooth connection. In alternate systems, the transmission may leverage an internet or cellular network backbone. In some embodiments, a plurality of network stages may be employed serially.

Regardless of pathway between the receiving device and downlink device, once received at the downlink device, the encoded signal may be decoded into the multiple signals, at 350. A jitter buffer ensures strict synchronization across the audio stream in different channels. Once separated, they may be leveraged on this relatively computationally rich device to perform a series of audio processing steps, at 360.

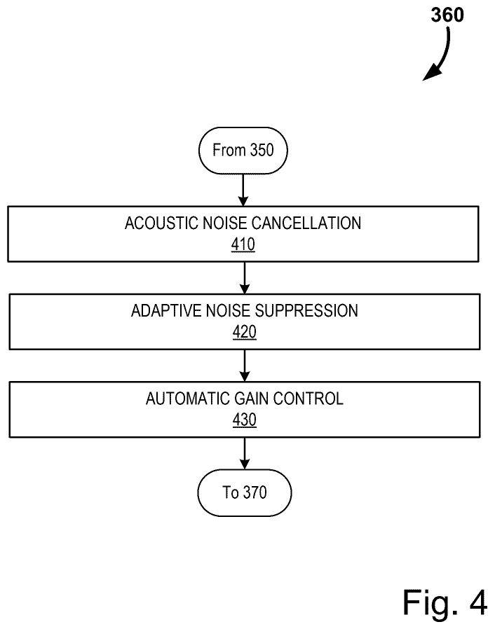

FIG. 4 provides a more detailed view of the audio processing steps. Initially, acoustic noise cancellation may subtract the far end signal from the near end signal to generate an echo cancelled signal, at 410. This echo cancelled signal is then provided to a subsequent circuit for cancellation of ambient noises, at 420. Adaptive noise suppression leverages multiple filters and other noise management techniques known in the field. This noise cancelled signal is lastly provided to the automatic gain control circuit for performing automatic gain control, at 430. Automatic gain control includes modulating the signal amplitude such that the signal has relatively consistent volume. Although not illustrated, additional downstream processing of the gain adjusted signal may be performed. For example, speech recognition software may transcribe the speech in the audio signal into machine readable information. Likewise, this information may be further processed, such as identifying command words, determining instruction sets, and the like.

Returning to FIG. 3, after audio processing, the final signal may be provided to a speaker for audio playback. This playback benefits from noise cancellation and echo removal as well as gain control, resulting in consistent and clear audio.

Although not illustrated, advanced methods of the present system may have the ability to select between uplink and downlink audio processing based upon the capabilities of the uplink sending device, the processing demands, and the audio size. In some embodiments, the uplink device may inform the downlink device which processing modules will be utilized. This signaling may be achieved using transmitted audio channels. For example, if the downlink device receives a mono-signal it may indicate uplink processing has already occurred and thus no downlink processing is required. Conversely, if a stereo signal is received, this may indicate to the downlink device that the audio processing needs to be performed at the downlink device.

Selection whether to process at the uplink device versus the downlink device may leverage different factors. For example, a short audio clip may be able to be processed at the uplink device, but longer audio signals may exceed the uplink device's buffer and may require processing at the downlink device. Alternatively, the downlink device may be connected to many uplink devices, each with different computational power. This system may allow uplink devices with more computational resources to perform the audio processing, and allows lower computational resourced devices to process the audio on the downlink device instead. In another example more closely tied to real-time communication, the audio signal may be framed with short (e.g., 20 ms) length sequential audio frames. The audio processing modules need to finish the processing for each frame within the set timeframe to ensure real-time processing requirements are met. If the uplink device is powerful enough, this requirement is satisfied with uplink audio processing, however, often the low-end uplink device is incapable of meeting this 20 ms (or other suitable short time window) requirement. In such cases, the processing may be shifted to the downlink device.

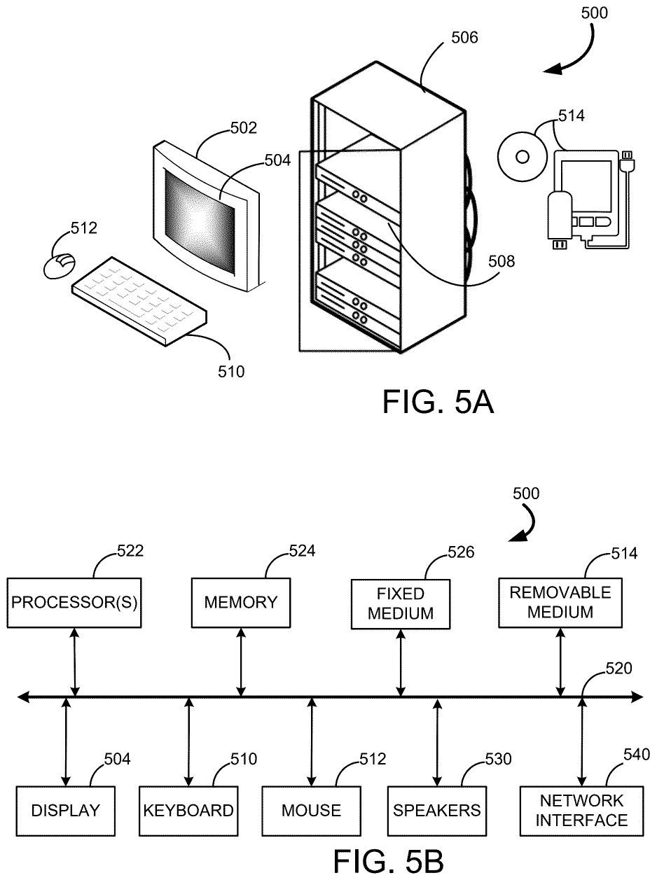

Now that the systems and methods for downline audio processing have been provided, attention shall now be focused upon apparatuses capable of executing the above functions in real-time. To facilitate this discussion, FIGS. 5A and 5B illustrate a Computer System 500, which is suitable for implementing embodiments of the present invention. FIG. 5A shows one possible physical form of the Computer System 500. Of course, the Computer System 500 may have many physical forms ranging from a printed circuit board, an integrated circuit, and a small handheld device up to a huge supercomputer. Computer system 500 may include a Monitor 502, a Display 504, a Housing 506, server blades including one or more storage Drives 508, a Keyboard 510, and a Mouse 512. Medium 514 is a computer-readable medium used to transfer data to and from Computer System 500. FIG. 5B is an example of a block diagram for Computer System 500. Attached to System Bus 520 are a wide variety of subsystems. Processor(s) 522 (also referred to as central processing units, or CPUs) are coupled to storage devices, including Memory 524. Memory 524 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable form of the computer-readable media described below. A Fixed Medium 526 may also be coupled bi-directionally to the Processor 522; it provides additional data storage capacity and may also include any of the computer-readable media described below. Fixed Medium 526 may be used to store programs, data, and the like and is typically a secondary storage medium (such as a hard disk) that is slower than primary storage. It will be appreciated that the information retained within Fixed Medium 526 may, in appropriate cases, be incorporated in standard fashion as virtual memory in Memory 524. Removable Medium 514 may take the form of any of the computer-readable media described below.

Processor 522 is also coupled to a variety of input/output devices, such as Display 504, Keyboard 510, Mouse 512 and Speakers 530. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 522 optionally may be coupled to another computer or telecommunications network using Network Interface 540. With such a Network Interface 540, it is contemplated that the Processor 522 might receive information from the network, or might output information to the network in the course of performing the above-described audio processing methods. Furthermore, method embodiments of the present invention may execute solely upon Processor 522 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 500 can be controlled by operating system software that includes a file management system, such as a medium operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, Glasses with a processor, Headphones with a processor, Virtual Reality devices, a processor, distributed processors working together, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer (or distributed across computers), and when read and executed by one or more processing units or processors in a computer (or across computers), cause the computer(s) to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for downlink audio processing comprising:
receiving an audio signal at an uplink device;
converting the audio signal to a near-end signal;
collecting a far-end signal;
encoding the near-end signal and the far-end signal into an encoded bit stream;
transmitting the encoded bit stream to a downlink device;
decoding the encoded bit stream at the downlink device to render a decoded near-end signal and a decoded far-end signal; and
performing audio processing at the downlink device using the decoded near-end signal and the decoded far-end signal to generate processed audio.

2. The method of claim 1, wherein the downlink device includes a jitter buffer when decoding the encoded bit stream.

3. The method of claim 1, wherein encoding the near-end signal and the far-end signal utilizes an audio codec with stereo coding capabilities.

4. The method of claim 3, wherein the codec includes at least one of Opus stereo, AAC, EVS, and IVAS.

5. The method of claim 1, wherein encoding the near-end signal and the far-end signal utilizes a mono coder that interleaves the near-end signal and the far-end signal in a time domain.

6. The method of claim 5, wherein the mono coder includes G.711 or G.722.

7. The method of claim 1, wherein the audio processing includes acoustic echo cancellation.

8. The method of claim 7, wherein the audio processing further includes adaptive noise suppression and automatic gain control.

9. The method of claim 1, further comprising playing back the processed audio at the downlink device.

10. The method of claim 1, further comprising performing additional processing of the processed audio using at least one machine learning algorithm.

11. A computerized system for downlink audio processing comprising:
an uplink device configured to receive an audio signal, convert the audio signal to a near-end signal, collect a far-end signal, encode the near-end signal and the far-end signal into an encoded bit stream, and transmit the encoded bit stream; and
a downlink device configured to receive the transmitted encoded bit stream, decode the encoded bit stream at the downlink device to render a decoded near-end signal and a decoded far-end signal, and perform audio processing using the decoded near-end signal and the decoded far-end signal to generate processed audio.

12. The system of claim 11, wherein the downlink device includes a jitter buffer when decoding the encoded bit stream.

13. The system of claim 11, wherein encoding the near-end signal and the far-end signal utilizes an audio codec with stereo coding capabilities.

14. The system of claim 13, wherein the codec includes at least one of Opus stereo, AAC, EVS, and IVAS.

15. The system of claim 11, wherein encoding the near-end signal and the far-end signal utilizes a mono coder that interleaves the near-end signal and the far-end signal in a time domain.

16. The system of claim 15, wherein the mono coder includes G.711 or G.722.

17. The system of claim 11, wherein the audio processing includes acoustic echo cancellation.

18. The system of claim 17, wherein the audio processing further includes adaptive noise suppression and automatic gain control.

19. The system of claim 11, further comprising playing back the processed audio at the downlink device.

20. The system of claim 11, further comprising performing additional processing of the processed audio using at least one machine learning algorithm.
